(19) United States
(12) Patent Application Publication
(10) Pub. No.: US 2010/0036296 A1
(43) Pub. Date: Feb. 11, 2010

(54) Apparatus for the Oscillation of the Foot and to Activate the Blood Stream

(76) Inventor: Juan Andres Sancho Serrats, Sant Joan Despi (ES)

Correspondence Address: NIXON & VANDERHYE, PC, 901 NORTH GLEBE ROAD, 11TH FLOOR, ARLINGTON, VA, 22203, US

(21) Appl. No.: 11/794,466

(22) PCT Filed: Dec. 30, 2005
(86) PCT No.: PCT/IB05/03915

§ 371 Date: Oct. 14, 2009

(30) Foreign Application Priority Data
Dec. 30, 2004 (ES) U200500006

(51) Int. Cl. A61H 1/02

(52) U.S. Cl. 601/31

(57) ABSTRACT

Comprises a base (1), a liftable platform (2), a driving means (3) of the referred platform (2) and a feeding means of the referred driving means, characterized in that the aforementioned base (1) and the liftable platform (2) are articulated between themselves, describing an angle of between 15° and 25° in a resting position and in a highest elevation position reach an angle of between 30° and 45° and in that also in an operative position, the heel (4) of the foot is articulated out of the apparatus, being the forefoot (5) and at least a part of the plantar sponge (6) positioned over the liftable platform (2).

Apparatus for the oscillation of the foot and to activate the blood stream of the type that comprises a base, a liftable platform, a driving means of the referred platform and a feeding means of the referred driving means, characterized in that the aforementioned base and the liftable platform are articulated between themselves, describing an angle of between 15° and 25° in a resting position and in a highest elevation position reach an angle of between 30° and 45° and in that also in an operative position, the heel of the foot is articulated out of the apparatus, being the forefoot and at least a part of the plantar sponge positioned over the liftable platform.

### BACKGROUNDS OF THE INVENTION

Several Spanish Utility Models that belong to Mr. Ángel ALMANSA PASTOR are known in the state of the art. Among all of them worth a special mention the Utility Models n. 0238952, 0241319, 0255767, 0253173, 0249179, 0248559 and 0276615.

Thus, the Utility Model n. 0238952 of the year 1978, refers to a gymnastic apparatus to activate the blood stream, essentially characterized in that it consists of two intercommunicate bellows in closed circuit, mounted on a suitable mount, with the enough air for the fill of one of them, equipped with a foothold for the feet of the user, which will put pressure on the bellows in a alternately manner with similar movements to pedal.

The n. 0241319 of the year 1979 refers to a gymnastic apparatus to activate the blood stream, essentially characterized in that it consists of a portable base in which are mounted two articulated pedals, with means for supporting and fastening the feet, which pedals are pushed by respective helical springs of adjustable tension.

The n. 0255767 of the year 1981, refers to an apparatus for the rehabilitation of lower extremities and to tone up the blood stream characterized in that it consists of a semipyramidal case which upper face has apertures in which articulate each one of the pedals made in the same material of the case in such a way that push during its swinging at the lower face, an articulated wheels to an angled lever that is hinged in the centre by a fulcrum to the case so that its free end strain in extension or pull in traction, a number of other springs that present a resistance to the movement of the feet pushing on the pedals and which springs are lined to prevent resonances during its extension or traction achieving a pendulous movement of feet of flexion-extension of the articulation while the movement of the knee is minimum and there is not movement in the hip, being able the adaptation of an electronic metering method or stress mechanics.

With regard to the Utility Model n. 0253173, characterized in that it consists of a supporting case pyramid or laying frustum shaped with the ramp towards the user and in which edge or less height area two flat pedals articulate and actuate in sliding thrust and at the back, over a number of other pistons linked to the orthogonal rods of the pins of both of the oleohydraulic cylinders which pistons, with an adjustable pitch, provide the necessary resistance for the displacements of the foot of the user keeping the movement of the knee to a minimum and practically no existent the movement of the hip.

With regard to the year 1980, the Utility Model n. 0249179 claims an apparatus for the rehabilitation of the lower extremities characterized in that it consists of a mount as an open case, in one of its vertical planes are hinged two pedals with the suitable outfit to hold the feet of the patient and whose pedals are alternately moved by means of cams pulled by a motor driven shaft, with or without a speed reducer, and against of which kept supported by means of the stretching action of each springs, which attraction ensures the continuous contact between both pieces and over a go-between contact that consists in a needle roller bearings shoe or a plate with rollers.

Also, from the year 1980 is the n. 0248559, that defines a gymnastic apparatus to activate the blood stream, essentially characterized in that it consists of a container bearing two pedals with the suitable means to rest the feet and which are articulated and pushed upwards by means of two springs whose heads are fitted in each centre plate of which the upper one with a bigger diameter is overlapping the lower one and are fixed to each sliding trolleys through guides coaxial with the pedals, so that the centre of the lever can be changed achieving a higher or lower resistance and with a seesaw motion adjustable in its reversing by means of the antagonist action of a clamped spring by one end to the bottom of the case, and by the other to a projecting lug of one side of each pedal that fitted in a slot of a guide in hinged arch, adjust with its inner stress, although provided to that of the main springs, the sudden lifting of the pedals, but without interfering the normal operating.

Finally, the n. 0276615 of the year 1983, refers to a physiotherapy apparatus to activate the blood stream, that comprises a box shaped casing over which upper base are arranged two inferiorly articulated pedals, at its rear side to said box, characterized in that on the inside of the casing there is housed an electric motor, equipped with an adjustable electroreducer, which motor actuates a spindle that gear with a crown or a notched pinion, which axis has near of each one of its ends two consecutive bendings in right angle, guided so that to form two cranks at an angular offset of 180 degrees between themselves, at which outer section are articulated each connecting rod connected with two pedals in a centre situated at the front of the hinge of said pedals to the casing, so that when the motor is connected cause an alternating up and down movement of both pedals.

### BRIEF DESCRIPTION OF THE PATENT

The present invention intends to be an improvement of the aforementioned Spanish Utility Models, increasing the blood stream through the oscillation of the foot.

To walk is one of the best exercises to activate the blood stream, the contraction and the stretching of the muscular groups of the legs, squeeze the veins by compression and increase the blood speed in said veins and it is caused the suction of the veins contained blood towards other veins with a higher diameter and flow by Venturi effect.

Walking is not always possible owing to tiredness, illness, for labour reasons or due to be in small places and it involves the risk of suffering circulatory problems in persons with tendency (varices, obesity, coagulant disorders, pregnancy).

Thus, in the background art were mentioned apparatuses that could solve part of the aforementioned problems, although the apparatuses were not the appropriate ones since they are equipped with springs (0241319, 0248559 and 0255767), being the first of them by the downwards thrust of the toe, with a considerable effort by the patient or user and the second one obliges to a forced position of the foot and fix a very short path; other that included air bellows (0238952); with an oleohydraulic cylinder (0253173); with a mechanic driving power, with motor (0249179), but in this case the position of the foot over the pedals causes a considerable uncomfortable for the user because the position of the foot and the pedal action force the leg to move downwards and a long path of flexion downwards the foot is not possible because it causes a forced flexion and non-effective as for the action of the calf muscle pump (short path); and with two pedals and a crankshaft mechanism (0276615), with a complete rest of the foot and a heavy and noisy mechanism also.

The present invention intends to avoid the blood stagnation that occurs when staying seated for a long period of time, so being for labour reasons, for making long haul flights, intercity rail or coach travels, etc.

The particular configuration of the apparatus involves the following improvements for the user o patient that use it:
Reduction of the risk of complications for muscle pump inactivity, such as venous thrombosis (Economy class syndrome),
Reduction of the edema that occurs following leg surgery, and
Reduction of the feeling of leg heaviness after being seated for several hours.

The main function of the present apparatus is to cause in a passive way the movements of the calf muscle pumps of the leg anterior compartment and the plantar sponge of the foot, in order to facilitate the venous return circulation and to avoid the venous stasis (stagnation of the blood) in the leg. This stagnation is the main cause of the appearance of thrombosis of the blood vessels of the legs (Economy class syndrome) aforementioned.

The increase of the venous return also reduces the formation of edemas (liquid retention), the feeling of heaviness, tiredness and pain. That is to say, there is an improvement of the symptoms caused by the inactivity.

The veins are responsible for transporting the deoxygenated blood back to the heart while the arteries are responsible to carry oxygen and vital nutrients to our most important organs and muscles. Because of the veins must work against the force of gravity their structure is more prepared that the structure of the arteries and include a system of valves preventing the blood to return down again. A pump mechanism helps the veins to carry the blood back to the heart that consists of:
The plantar sponge or Lejars venous plexus: with every step the veins of the sole of the foot are compressed, causing thus the upwards flowing of the blood.
The calf pump and the thigh pump: these muscular pumps are activated when walking.

The plantar sponge plays a very important part and is indispensable in the venous system of the lower members.

The blood pumped by the heart to the lower extremities must be pumped uphill in spite of several inconveniences such as its distance that works against the effect of the initial starting pressure and the gravity that has tendency to contribute to its stagnation in the lowest blood vessels.

The venous return is very favoured by the statics of the foot that produces a muscular contraction of the lower members, which produces a real venous massage. When walking, it is added the compression of the plantar veins, which are empty at each step, just as it is shown by the paleness of the skin under the plantar support area. There is a real communication system between the plantar veins and the dorsal veins which facilitates the venous return via the deep system. The sole of the foot can be considered as a genuine peripheral heart.

This often unknown attribute is becoming apparent in the mechanism of appearance of the phlebitis in the lower member. The venous return can get complicated to the stasis in an adult that remains seated many hours contributing to the develop of blood clots responsible of the appearance of the phlebitis (economy class syndrome)

Factors that contribute to venous return:
Plantar venous squeezing: this mechanism gives to the venous blood its initial venous impulse of return, in fact the squeezing of the plantar sponge (metatarsian, arch and marginal veins of the sole of the foot) with each step causes an evacuation of the contents of the blood vessels like a sponge. Said squeezing is so effective because the perforating veins are practically devoid of valves at that level and allow like this the communication of the deep and superficial venous systems.
Vis a tergo: is the residue of the propelling force of the left ventricle transmitted to the veins through the capillaries and arterial venous anastomosis.
Calf muscle pump: while walking (contraction) externally compresses causing the empty of the intermuscular veins to the deep system and causes in relaxation the aspiration of blood from the superficial system to the deep system through the perforating veins.

Therefore, the present apparatus has an specially effect in the plantar venous squeezing, or what is the same thing, stimulating the plantar sponge, increasing the risk of the blood flow in a simulated walking action, and in the activation of the muscular pumps of the calf and tibio fibular leg.

Furthermore, it is also directed for the postoperative rehabilitation of the orthopaedic surgery of the lower extremities, because activates the muscle pump even if the patient remains seated or lies down.

The fact of resting the heel out of the liftable platform involves on the one hand that with an identical elevation a higher arch is created and on the other hand less energy is consumed, since the weight of the whole leg do not fall on the apparatus but partially the foot.

An object of the present invention is an apparatus for the oscillation of the foot and to activate the blood stream of the type that comprises a base, a liftable platform, a driving means of the referred platform and a feeding means of the referred driving means, characterized in that the aforementioned base and the liftable platform are articulated between themselves, describing an angle of between 15° and 25° in a resting position and in a highest elevation position reach an angle of between 30° and 45° and in that also in an operative position, the heel of the foot is articulated out of the apparatus, being the forefoot and at least a part of the plantar sponge positioned over the liftable platform.

### BRIEF DESCRIPTION OF THE DRAWINGS

With the purpose to facilitate the explanation two sheets of drawings are attached to the present description, in which a practical case of an embodiment has been reproduced, which is mentioned only for exemplificative, non limitative of the scope of the present invention:

FIG. 1 is a side view of the object of the present invention in a highest elevation position of the liftable platform.

FIG. 2 is a side view like the one of the FIG. 1 but in a lowest elevation position of the liftable platform.

FIG. 3 is a bottom view of the foot, viewed from the sole, showing the position of the plantar sponge.

### PREFERRED EMBODIMENT OF THE PATENT APPLICATION

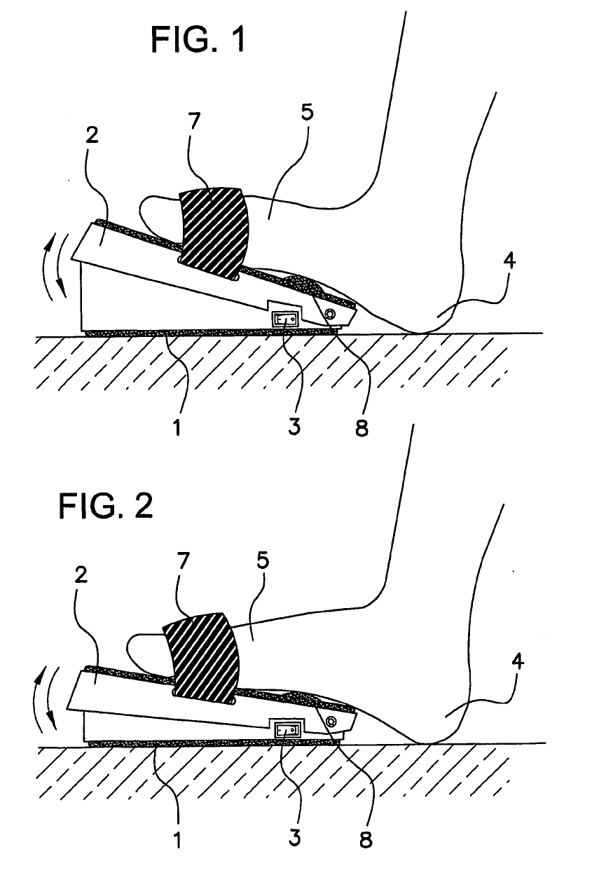

Thus, in the FIGS. 1 and 2 is shown a base 1, a liftable platform 2, a driving means 3, and a heel 4 of the foot, a forefoot 5 and a fastening means 7 from the foot to the liftable platform.

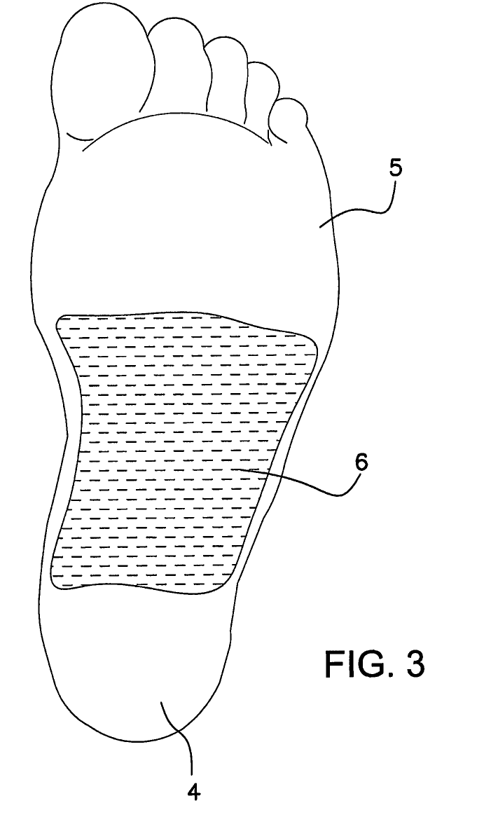

In the FIG. 3 is shown the heel 4, the forefoot 5 and a plantar sponge 6.

Thus, in a preferred embodiment, in a transoceanic flight where the passengers remain seated for a long time, at least an apparatus object of the present invention is distributed to all of the passengers for its alternately use in each foot.

In this way, the user places the forefoot 5 and the plantar sponge 6 over the liftable platform 2 (depending on the size and the shape of the foot, will be smaller or bigger the plantar sponge area in contact with the liftable platform).

Likewise, the heel 4 rest on the floor so that it can be used as an articulating element between the own foot and the leg.

Next, are bring into operation the driving means 3 of the liftable platform 2, itself known such as for example a piston, a cam, a magnetic system, etc.

In principle, would be suitable that the revolutions or oscillations were at between 10 and 40 per minute, depending on the person, being in general around 20 per minute accurate enough, being the step cycle rate of a person in the street.

The liftable platform 2 will be at an angle of between 15° and 25° with respect to the base 1 in a resting position and in a highest elevation position reach an angle of between 30° and 45°.

So, the inventor with this apparatus aims to increase and activate the blood stream toward the heart but without the collaboration of the patient or user that activates the whole venous system of the leg without realize it.

In this way, the person seated in his flight passenger seat, while watching a movie, or sleeping, the apparatus allows the plantar sponge 6 and the muscle pump of the leg to pump blood and avoid the aforementioned Economy Class Syndrome.

In order to increase the pressure on the plantar sponge 6 and the consequent blood flow, the inventor has found quite appropriated to put a protuberance 8 above the liftable platform 2, so that to coincide with the area above which is situated the plantar sponge 6 of the foot, (FIGS. 1 and 2), which is pressed by said protuberance 8.

The present patent application describes a novel apparatus for the oscillation of the foot and to activate the blood stream. The examples here mentioned are not limitative of the present invention, for that reason it will be able to have different applications and/or be adapted, all of them within the scope of the following claims.

1-4. (canceled)

5. An apparatus for the oscillation of the foot and to activate the blood stream, comprising:
a base;
a lifting platform coupled to the base, wherein the platform articulates with respect to said base;
driving means for driving the platform; and
feeding means for the driving means, wherein when in the operating position, the platform is ready to receive a user's forefoot and at least a part of the plantar sponge, and wherein the user's heel is positioned out of the platform, wherein when in a resting position, said base and the lifting platform form an angle of between approximately 15° and 25°, and in when in a highest elevation position, the base and the lifting platform form an angle of between approximately 30° and 45°, and wherein a protuberance is formed on the lifting platform at a position corresponding to an area of the lifting platform situated adjacent the plantar sponge of the user's foot.

6. The apparatus according to claim 1, characterized in that the driving means causes up and down movement of the liftable platform at between 10 and 40 revolutions per minute.

7. The apparatus according to claim 1, further comprising a fastening means for fixing the user's foot on the lifting platform.
